(19) United States
(12) Patent Application Publication
(10) Pub. No.: US 2007/0149218 A1
(43) Pub. Date: Jun. 28, 2007

(54) Method and apparatus for conveying regions for controlling a mobile device based upon location

(75) Inventor: Sean S. Lee, Potomac, MD (US)

Correspondence Address: THE DIRECTV GROUP INC, PATENT DOCKET ADMINISTRATION RE/R11/A109, P O BOX 956, EL SEGUNDO, CA, 90245-0956, US

(73) Assignee: The DIRECTV Group, Inc.

(21) Appl. No.: 11/443,787

(22) Filed: May 31, 2006

Related U.S. Application Data
(60) Provisional application No. 60/754,480, filed on Dec. 28, 2005.

(51) Int. Cl. H04Q 7/20

(52) U.S. Cl. 455/456.3

(57) ABSTRACT

A mobile wireless system (10) includes a transmitter such as a satellite (18) that broadcasts wireless signals such as boundaries for specific areas to a mobile receiving device (22). Mobile receiving device (22) may include an antenna (26) and a mobile receiving device (28). A locating receiver (50) is used to generate locating signals so that a determination may be made to the location of the mobile receiving device. In response to comparing the location and the boundaries, various behaviors of the receiving device can be controlled. Behaviors can include display or blockage of audio, video or data channels or other information may be used by the mobile receiving device.

### CROSS-REFERENCE TO RELATED APPLICATIONS

This application claims the benefit of U.S. Provisional Application No. 60/754,480, filed on Dec. 28, 2005. The disclosure of the above application is incorporated herein by reference.

### TECHNICAL FIELD

The present invention relates generally to a mobile receiving device, and more specifically, to a method for controlling the displayed information according to the location of the mobile receiving device based upon boundaries conveyed to the mobile device.

### BACKGROUND

Satellite television has become increasingly popular due to its wide variety of programming. Entertainment in automobiles such as DVD players has also become increasingly popular. It would be desirable to provide a satellite television system for a vehicle so that the wide variety of programming may be enjoyed by the rear passengers.

Federal regulations have specific boundaries for which satellite systems are allowed to display rebroadcasted local channels. A satellite system located within one boundary may only display video for all channels associated with that region. Current satellite systems do not include a means for determining a location.

It would therefore be desirable to provide a system that allows a mobile satellite system to comply with federal regulations for rebroadcasting local channels and take into consideration the possibility of changing boundaries.

### SUMMARY OF THE INVENTION

The present invention provides a method of operating a mobile device that takes into consideration the location of the mobile receiving device that is transmitted thereto.

In one aspect of the invention, a method of operating a mobile device comprises broadcasting boundaries for an area to a mobile device, receiving the boundaries for the area, storing the boundaries for the area in a memory, and controlling the device in response to the boundaries for the area stored in the memory

In a further aspect of the invention, a method of operating a mobile device comprises determining a location of the mobile device, broadcasting wireless signals having location specific information therein, and displaying the wireless signals when the location specific information coincides with the location of the mobile device.

In another aspect of the invention, a method of operating a television broadcasting system comprises broadcasting boundaries for a designated marketing area to a mobile device, receiving the boundaries for the designated marketing areas, storing the boundaries for the designated marketing area in a memory, determining a location of a mobile receiving device, determining a designated marketing area of the mobile receiving device, and receiving signals from the satellite in response to the designated marketing area.

The method may take into consideration a global positioning system or other device such as a cellular tower-based system, radio or TV tower for location determination.

One advantage of the invention is that federal regulations may now be met for mobile satellite television systems. That is, local channels may be coordinated so that they are provided to the system for display in the proper designated marketing area. Because boundaries of the designated marketing areas are broadcast to the mobile device, changes, additions or updates to the boundaries of such areas can be done dynamically.

Another advantage is that geographic areas of interest may be dynamically identified and updated to control IRD behavior. An example is identifying one or several tornado warning areas, broadcasting the boundaries of the areas to all mobile devices, and then mobile devices that determine that they are within the tornado warning areas will display warning text and/or change the channel to an emergency broadcast.

Other advantages and features of the present invention will become apparent when viewed in light of the detailed description of the preferred embodiment when taken in conjunction with the attached drawings and appended claims.

### Brief Description of the Drawings

FIG. 1 is a system level view of a satellite broadcasting system according to the present invention.

FIG. 2 is a block diagrammatic view of a vehicle having a receiving system according to the present invention.

FIG. 3 is a block diagrammatic view of the various logic of the antenna and the set top mobile receiving unit.

FIG. 4 is an example of various combinations of regions that can be described using polygons according to the present invention.

FIG. 5 is a flow chart illustrating one method for operating the present invention.

FIGS. 6A-6E are a top view of various polygons for use in a point inclusion detection algorithm.

FIG. 7 is a flow chart illustrating a point inclusion detection algorithm.

FIG. 8 is a top view of three adjacent polygonal direct marketing areas.

FIG. 9 is a top view of polygonal region A of FIG. 8 with a table identifying the corner points.

### DETAILED DESCRIPTION

In the following figures the same reference numerals will be used for the same views. The following figures are described with respect to a mobile satellite television system. However, those skilled in the art will recognize the teachings of the present invention may be applied to various types of mobile reception including land-based type systems.

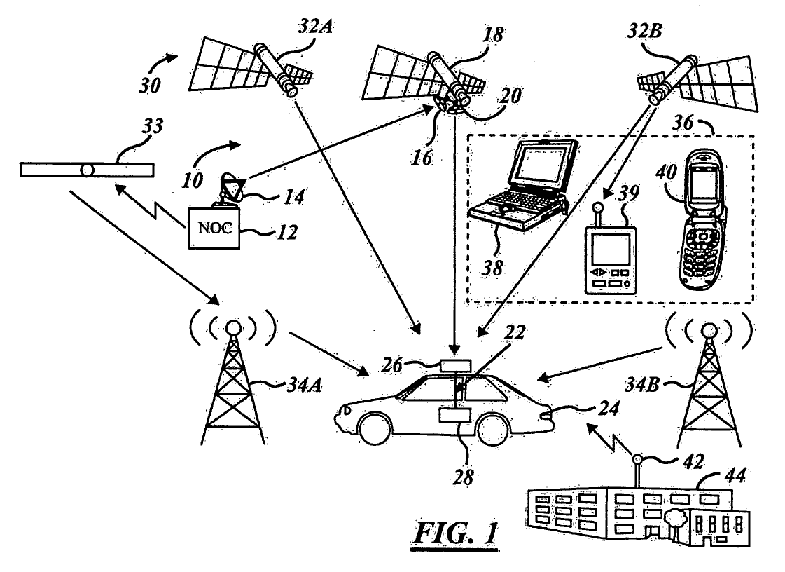

Referring now to FIG. 1, a satellite television broadcasting system 10 is illustrated. The satellite television broadcasting system 10 includes a network operations center 12 that generates wireless signals through a transmitting antenna 14 which are received by a receiving antenna 16 of a spaced-based system such as a satellite 18. The wireless signals, for example, may be digital. As will be described below, the wireless signals may be entertainment content or boundary point data for areas of interest such as designated marketing areas. Areas of interest may also include traffic, weather, hazardous material warning areas, advertising marketing area near a particular store or region or other types of areas. A transmitting antenna 20 generates signals directed to various receiving systems including stationary systems such as those in the home as well as mobile receiving systems 22. The wireless signals may have various types of information associated with them including location information. The wireless signals may also have various video and audio information associated therewith. As illustrated, the mobile receiving system 22 is disposed within an automotive vehicle 24. A receiving antenna 26 receives the wireless signals from the satellite 18 and processes the signals in a mobile receiving unit 28. The mobile receiving unit 28 will be further described below.

The system 10 may also receive location signals from a GPS system 30 that includes a first satellite 32A and a second satellite 32B. Although only two satellites are shown, a typical GPS system includes several satellites, several of which may be in view at any particular time. Triangulation techniques may be used to determine the elevation, latitude and longitude of the system. A locating system may also include cellular towers 34A and 34B that may be used by the mobile receiving system 22 to determine a location. The towers may be cellular phone, radio or TV towers. Cellular phones typically include a GPS locating system. As the vehicle 24 moves about, the exact coordinates in latitude and longitude may be used to determine the proper area of interest such as a designated marketing area which will control the mobile devices choices for local television and such broadcasted data.

The system may also receive boundary information such as boundary points of designated marketing area polygons from the terrestrial-based system such as the cellular towers 34A and 34B. In addition, the satellites may also be replaced with stratospheric platforms 33 for transmitting the designated marketing areas to the mobile device. Stratospheric platforms are manned or unmanned airplanes, airships, or the like that fly above commercial airspace. It is envisioned that stratospheric platforms may fly at altitudes between 60,000 and 100,000 feet from the surface of the earth. Thus, the stratospheric platforms are in a significantly lower position than even low earth orbit satellites.

The present invention may also be used for displaying various wireless information on a personal mobile device 36 such as a laptop computer 38, a personal digital assistant 39, and a cellular telephone 40. It should be noted that these devices and the automotive-based devices may also receive wireless signals having various types of information associated therewith from the cellular towers 34A and 34B. Other types of information may be broadcast from other types of broadcasting areas such as an antenna 42 on a building 44. The building 44 may be various types of buildings such as a store and the wireless information transmitted from the antenna 42 may be advertising information. All of the wireless signals preferably include location information transmitted therewith. As will be described below, the information may be coded digitally into the signals. Thus, by reviewing the location information, signals appropriate for the location of the mobile devices may be displayed on the various devices. This will be further described below.

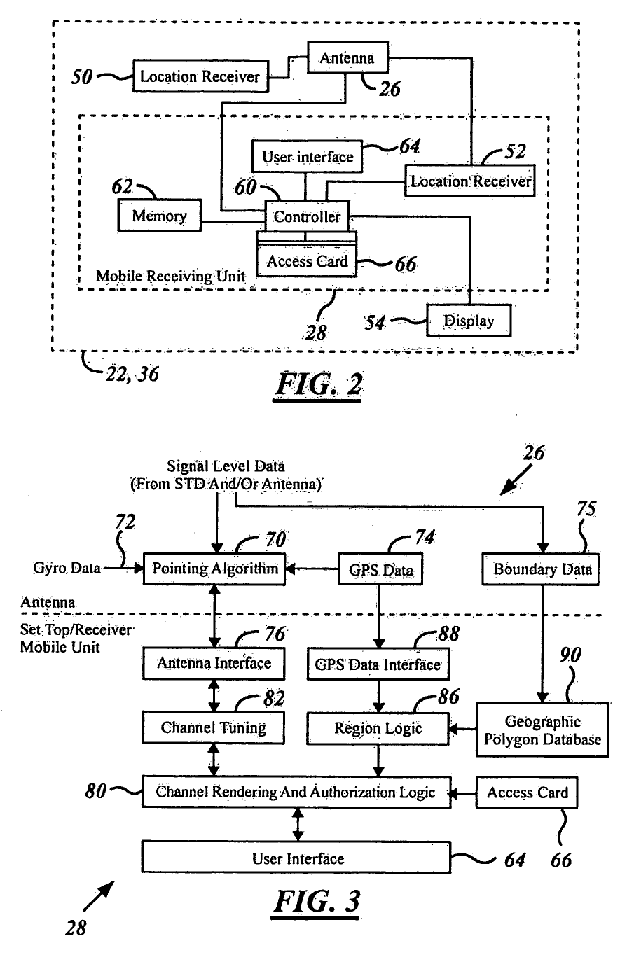

Referring now to FIG. 2, a receiving unit 22 is illustrated in further detail. Antenna 26 may be various types of antennas including a rotating antenna which is used to track the relative movement of the satellite or other transponding device with respect to the vehicle. The antenna 26 may be a single antenna used for satellite television reception, or a number of antennas such as one for receiving television signals and one coupled to a location receiver 50 such as GPS receiver. The antenna 26 may also be an electronic antenna.

The mobile receiving unit 28 is coupled to antenna 26. The mobile receiving unit 28 may also include a location receiver 52 integrated therein. The location receiver 52 may be a GPS receiver. In a preferred embodiment, only one location receiver 50, 52 may be provided in the system. However, the location receiver 50, 52 may be part of the vehicle 24 or may be part of the mobile receiving system 22, 36. The controller 60 may be coupled directly to GPS receiver 52 and/or GPS receiver 50. The mobile receiving unit 28 includes a display 54. The display 54 may be incorporated into the device 36 or within the vehicle 24.

A controller 60 that is microprocessor-based may be used to control the various functions of the receiving unit 28. Such functions include acting as a tuner, receiver, decoder, buffer and other functions. The controller may be similar to that found in current DirecTV set top boxes which employ a chip-based multifunctional controller. The controller 60 may include or be coupled to a memory 62. Memory 62 may be used to store the boundaries of various areas of interest received from the antenna as broadcast by one of the devices 32, 33 or 34 described above. An area of interest is a fixed geographic or cartographic area bounded by a closed shape such as a polygon, circle, curved or straight line segments, or the like. The fixed area or closed shape has outer boundaries that do not move on the surface of the earth. As will be shown below, areas may be excluded (island-like) within a closed shape. Although the areas are fixed, they may be, from time to time, redetermined and rebroadcast to the mobile device for usage. A key feature is that as the vehicle or mobile device moves, the area of interest remains fixed on the surface of the earth and thus the device may enter into another area of interest. Boundaries of certain areas of interest such as a designated marketing area (DMA) may be defined by Nielsen and may be pre-programmed into the memory 62 as a number of polygons wherein each point of each side is defined in cartographic coordinates of longitude and latitude and fractions of degrees. As will be described below the polygons may be formed of corners whose latitude and longitude are stored within the memory.

The location receiver 52 is capable of providing latitude and longitude to the controller 60. The controller 60 may be used to compare the location signals from the location receiver 50, 52 to the boundaries of the areas of interest such that the mobile device can determine which areas of interest it is within and which areas of interest it is not within. From this determination it can control IRD behavior such as allowing or disallowing display of certain audio or video channels. One application is to broadcast areas of interest that represent designated marketing areas to determine which designated marketing area the mobile device is within and which area it is not within, which signals the system should be receiving. These signals may coincide with or coordinate to the local broadcasting signals for the specific designated marketing area. It should be noted that more than one designated marketing area may be provided for a particular area. That is, adjacent areas may also be authorized for viewing. Various fringe regions may be used around a particular designated marketing area to provide hysteresis for the system. This function will be further described below.

The controller 60 may also be coupled to a user interface 64. User interface 64 may be various types of user interfaces such as a keyboard, push buttons, a touch screen, a voice activated interface, or the like. User interface 64 may be used to select a channel, select various information, change the volume, change the display appearance, or other functions. The user interface 64 is illustrated as part of the mobile receiving unit. However, should the unit be incorporated into a vehicle, the user interface 64 may be located external to the mobile receiving unit such as dial buttons, voice activated system, or the like incorporated into the vehicle and interface with the mobile receiving unit.

An access card 66 may also be incorporated into the mobile receiving unit. Access cards such as conditional access module (CAM) cards are typically found in DirecTV units. The access card 66 may provide conditional access to various channels and wireless signals generated by the system. Not having an access card or not having an up-to-date access card 66 may prevent the user from receiving or displaying various wireless content from the system.

Referring now to FIG. 3, a block diagrammatic view of the mobile receiving unit 28 and the antenna 26 is illustrated. The boxes here represent the software logic that may be used to implement the invention. Various information may be associated with the antenna 26. The antenna 26 may include a pointing algorithm 70 therein. The pointing algorithm 70 may receive information from gyros in the antenna and be provided as gyro data 72. GPS data 74 may be provided from the GPS or location receiver 50, 52 illustrated above in FIG. 2. Other information may be provided from the mobile receiving unit such as channel tuning information and the like.

The antenna may also be used to receive boundary data 75 from the various sources described above. The boundary data may be received from a satellite, a terrestrial-based system, or a stratospheric platform. The boundary data 75 is stored within the memory 90. The boundary data may include many forms including equations for line segments, corners of intersections of line segments in latitude and longitude, or other information defining the boundaries of the designated marketing areas.

The mobile receiving unit 28 may include an antenna interface 76 that is used to communicate with the antenna. The antenna interface 76 formats the signals from the mobile receiving unit. For example, various signal level data such as the channel tuning information may be provided. Data from the user interface 64 and the conditional access card 66 may be used by the channel rendering and authentication logic 80. The channel rendering and authentication logic 80 may authorize the particular user based upon the conditional access card. Information entered from the user interface such as a password may also be used in the authentication logic. Various methods for authentication are well known in the art. The channel rendering portion of the channel rendering and authentication logic 80 receives information from the user interface 64 as to which wireless signals the user would like to receive. The channel rendering and authentication logic 80 generates signals that are provided to the channel tuning logic 82. The channel tuning logic 82 provides channel tuning information based upon the channel rendering information. The channel tuning logic 82 may include a receiver and a decoder used for receiving and decoding the appropriate channels. The channel tuning logic may provide information to the antenna interface 76 such as the direction of the signal or satellite that contains the particular channel that is desired. This information may be used by the pointing algorithm 70 to rotate the antenna in the appropriate direction.

The controller may also include receiving logic 86. The receiving logic 86 may provide information to the channel rendering logic as to the particular region that the antenna or the mobile receiving unit is located. The region logic 86 may be coupled to the GPS data interface 88. The GPS data interface 88 provides GPS information to the region logic so that appropriate signals may be received or displayed.

One use of the receiving logic 86 is that based upon the GPS signals, the location of the receiving unit may be selected. The receiving logic 86 may then look up in a geographic polygon or location database 90 which designated marketing area the receiving device is located. From this information the appropriate geographically specific data such as local broadcast television channels may be selected. The database 90 may consist of polygon boundary information used to define the marketing areas. The database 90 may also include other information such as zip code information or other ranges of data used for comparison with the signals. As will be evident to those skilled in the art, the wireless signals may be received with various location data used to identify the location appropriate for the signal to be displayed in. For example, the data may include information such as that the particular signal may be a local broadcast from the Washington, DC area, whereas other signals may indicate local broadcasting from the Baltimore area. When the vehicle is in the proper location, the proper signal may be displayed on the mobile device.

The location information may be provided in various portions of the signal. If the signal is an all digital signal the location information may be provided in a preamble of the information packet. If the signal is an analog signal the location data may be included in a vertical blanking interval of an analog television signal or as unused bandwidth of a digital television signal. In a purely analog signal, the location data may be superimposed digitally on the analog signal.

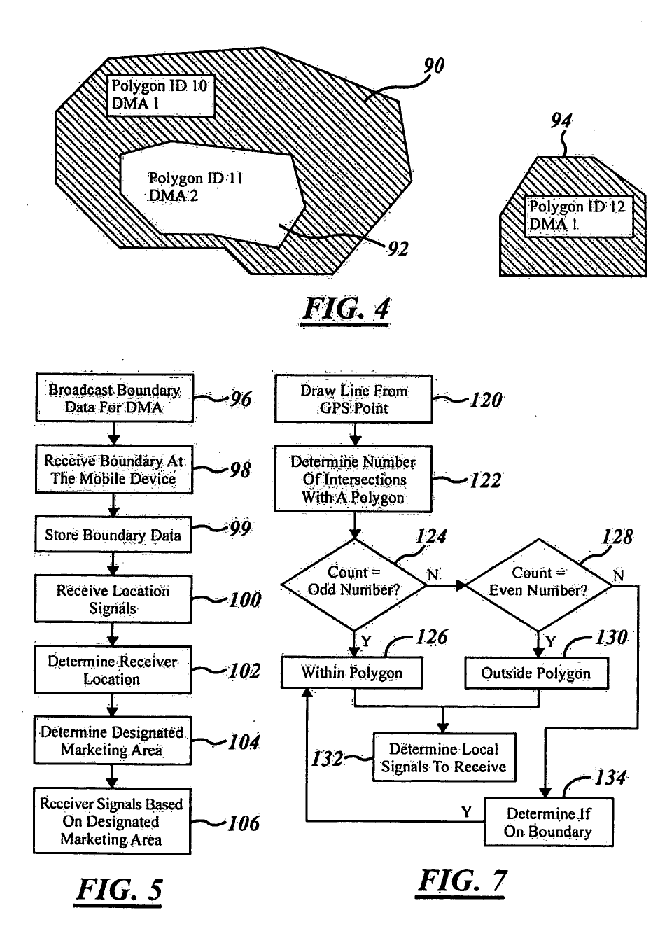

Referring now to FIG. 4, an example of a complex fixed designated marketing area on the surface of the earth is shown. A polygon having ID 10 and an assigned market area value of 1 is shown as area 90. Area 92 corresponds to a polygon ID of 11 and an assigned market ID value of 2. Polygon 94 is also of market area 1 and has a polygon ID of 12. It should be noted that each of the polygons are closed polygons. It should also be noted that there is no overlap between Area 92 and Area 90 such that Area 92 is an island inside Area 90. Area 90 taken by itself contains a hole the shape of Area 92. One method for determining boundaries of a polygon as a set of longitude and latitude points is set forth as:

typedef struct {

polygon id
number of polygon points
for (i = 0; i < number of market areas in object; i++) {

latitude degrees value
latitude 1/1000 minutes value
longitude degrees value
longitude 1/1000 minutes value

} POLYGON_T;

The unique polygon ID may be used in a data structure such that the designated marketing area can be a set of unjoined polygons as well as excluded regions as set forth in:

typedef struct {

DMA id
length of DMA
number of included regions
for (i = 0; 1 < number of included regions; i++) {

polygon Id

}
number of excluded regions
for i = 0; i< number of excluded regions; i ++) {

polygon id

} DMA T:

A representation of the designated marketing area 1 may be illustrated in code as:

| | |
|---|---|
| DMA id | 1 |
| number of included regions | 2 |
| polygon id | 10 |
| polygon id | 12 |
| number of excluded regions | 1 |
| polygon id | 11 |

Referring now to FIG. 5, a method for operating a television broadcasting system is illustrated. In step 96 the boundary data for the designated marketing area is broadcast by one of the types of devices described above such as a satellite, a terrestrial-based antenna, a cellular tower, or stratospheric platform. In step 98 the boundary information is received at the mobile device. In step 99 the boundary data is stored in the memory of the mobile device.

In step 100, the system or mobile device receives location signals. The receiver location is determined from the location signals in step 102. As mentioned above, the location signals may use GPS satellites or cellular telephone systems for determining the exact longitude and latitude down to an acceptable limit to determine the location of the mobile receiving device.

In step 104, the designated marketing area for the receiver location is determined. As mentioned above, various polygons or the like may be stored in the memory of the receiving device so that the particular designated marketing area at that moment in time for the position of the mobile receiving device may be determined. A lookup table for coordinates may be set forth or polygonal areas may be set forth to determine in which designated marketing area the mobile receiving device is located. If the system is not used for television signals, this step may be optional. Determining inclusion within a designated marketing area is set forth in FIG. 7.

In step 106, the controller of the system selects the particular local channel based upon the determination of the designated marketing area in step 84. Of course, some hysteresis may be accounted for in this method.

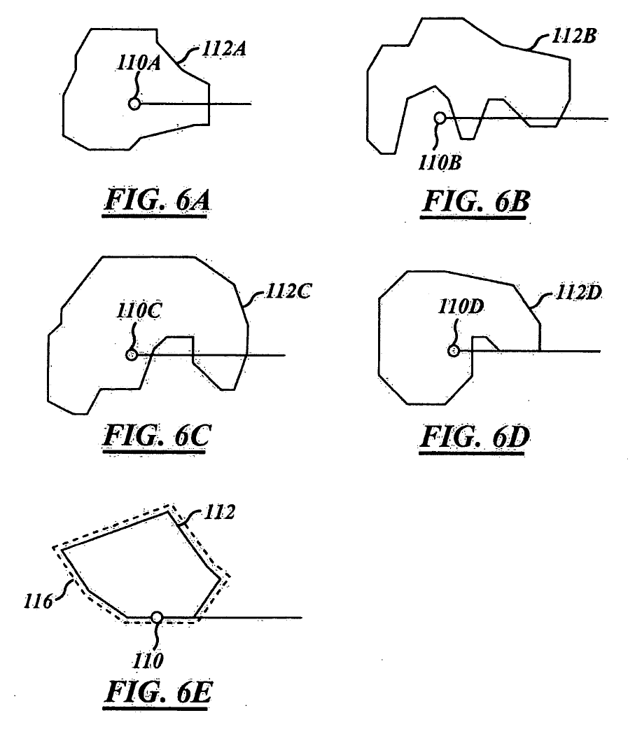

Referring now to FIGS. 6A-6D, various irregular shaped closed polygons are illustrated. The mobile device is located at the respective point 110A-110D in each of the various figures, respectively. The polygonal shapes 112A-112E are shown as irregular shapes. When the system is operated, it is not known whether the mobile device is located within or outside of the boundaries. One method for determining this is using a point inclusion detection algorithm. A line is arbitrarily drawn in a direction from the mobile device or point 110 in each of the figures. This is performed using a raycasting technique. In the raycasting the number of intersections with a line is determined. Although in FIG. 6 horizontal lines are shown, various other directions may be drawn.

In FIG. 6A, the number of intersections between the point 110A and the polygon is one. Therefore, any odd numbered amounts correspond to the mobile device being within the polygon.

Referring now to FIG. 6B, four intersections of the line from point 90B is illustrated. Thus, a count of the number of intersections is four and thus the point is outside the polygon.

In FIG. 6C, three intersection points are counted. Therefore, the point 90C is within the designated marketing area.

In FIG. 6D, the points of the polygon are on the GPS points line. In this case, all the polygon points should be ignored as intersections and only when the polygon's points have crossed the GPS line should an intersection be counted. In this case, there is just one intersection and the GPS point is therefore inside the polygon because of the odd number.

In summary, an odd number of intersections indicates that a point is within a polygon. An even number of intersections indicates the GPS point is outside the polygon.

Referring now to FIG. 6E, the GPS point 110E is on the boundary of the polygon. In this case the GPS point will be defined as being inside the polygon. Because the boundary of one polygon is likely to be the boundary of an adjacent polygon, the GPS point 110E may be a member of multiple regions when it lies on the boundary lines between the areas of interest. This may be confusing for a system. Therefore, if the mobile device is within the polygon and is moving toward the boundary, hysteresis buffer zone 116 may be provided around the polygon so that not until the vehicle or mobile device leaves the buffer zone 116 would the behavior of the mobile device change.

Referring now to FIG. 7, a method for performing a point inclusion detection algorithm is illustrated. In step 120, a line is drawn from a GPS point. In step 122, the number of intersections of the line with the closed polygon is determined. In step 124, if an odd number is counted in step 124, step 126 determines that the system is within the polygon and within the designated marketing area.

Referring back to step 124, if the count is not odd step 128 is executed. In step 124 if the count is even, the system is outside the polygon in step 130. If the count is not even or odd in step 128 step 132 is executed in which it is determined whether or not the system is on a boundary. A boundary system is illustrated in FIG. 5E above. If the system is on a boundary, the system determines whether it is within a polygon in step 134. After both steps 126 and 130 are executed, the controller of the system determines the local signal to receive based upon the designated marketing area. These channels are displayed on the display of the receiving device.

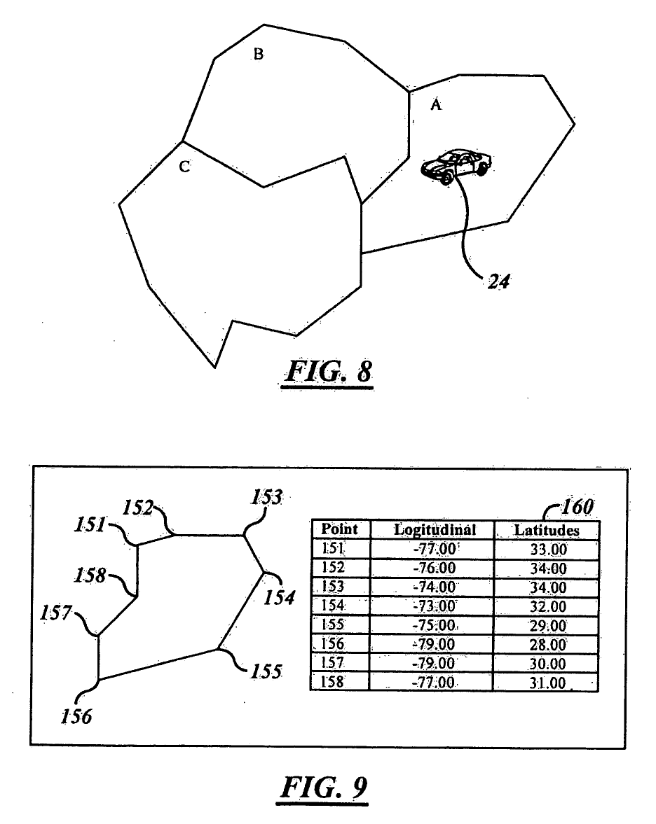

Referring now to FIG. 8, a plurality of designated marketing area polygons are illustrated as A, B, and C. At some segment each of the polygons are adjacent to each other. The points representing each polygon may follow any arbitrary rule such as political boundaries, geographic boundaries, or any areas of interest. Various types of information may be transmitted to the mobile device such as vehicle 24 to convey the boundaries. In one implementation, the mobile device may receive corner points in latitude and longitude . Based upon the boundaries of the polygon, the device may determine in which polygons it is inside and which it is outside. Various actions may be performed by the mobile device as a result of determining which polygon it is in based upon coded actions or instructions that use the broadcasted polygon.

Referring now to FIG. 9, polygon A of FIG. 8 is illustrated in further detail. Each of the corner points represents an intersection of two line segments of the polygon. In this example, points 151 through 158 represent corners of the polygon. Table 160 includes the point, the longitude and the latitude of each of the corner points. Thus, the points representing the polygon may be transmitted in a data structure that will be received by the receiving device as an object used for comparison with the GPS location. One example of a C-style structure of an object is set forth below.

struct geographic_polygon {

| | |
|---|---|
| int | unique_id; |
| int | version; |
| int | number_of_points; |

for (i = 0; i < number_of_points; i++) {

| | |
|---|---|
| int | longitude_degrees; |
| int | longitude_minutes; |
| int | longitude_seconds; |
| int | latitude_degrees; |
| int | latitude_minutes; |
| int | latitude seconds; |

}

}

Thus, each geographic polygon may be transmitted as a unique object that may be referenced individually. In this manner, a series of geographic polygons can be transmitted to a mobile device and stored in a memory such as dynamic random access memory or a non-volatile memory such as flash memory. This memory may then be periodically referenced as the mobile device's GPS coordinates change. By comparing the GPS coordinates with the polygonal boundaries, the receiving device may determine which polygon it is in and which polygon it is outside of. Various actions may be taken in response to the particular polygon, such as the types of displays or assorted messages may be displayed to the user, various audio clips may be played, allowing or blocking various channels to be displayed on the display device, or tuning to a particular broadcast channel may be performed in response to the comparison to the polygonal boundaries and the GPS coordinates.

One example of a use of broadcasted polygons is for providing designated marketing areas for local channel display or blockage. The satellite or other device may broadcast a geographic polygon for each designated marketing area because the designated marketing area has a unique ID and version, updates to a particular polygon representing a designated marketing area may be dynamically performed in the future. The mobile receiver then evaluates its location in reference to which polygon it is in and as a result, various expressions may be activated or deactivated. This may take the form of activating or deactivating various local channels.

Another example of the use of the present invention is in emergency weather situations where all mobile receiving devices in a geographic area may be notified of an impending severe weather situation. This may also be used for non-weather situations such as in conveying disaster information. In this manner, a complex polygon may be broadcast and vehicles within the polygon may receive the message detailing the specific weather or other type of alert.

While particular embodiments of the invention have been shown and described, numerous variations and alternate embodiments will occur to those skilled in the art. Accordingly, it is intended that the invention be limited only in terms of the appended claims.

What is claimed is:

1. A method of operating a mobile device comprising:
broadcasting boundaries for an area to a mobile device;
receiving the boundaries for the area at the mobile device;
storing the boundaries for the area in a memory;
controlling the device in response to the boundaries for the area stored in the memory.

2. A method as recited in claim 1 wherein the area corresponds to a designated marketing area.

3. A method as recited in claim 1 wherein broadcasting comprises broadcasting from a terrestrial source.

4. A method as recited in claim 1 wherein the area corresponds to a closed shape.

5. A method as recited in claim 4 wherein the closed shape corresponds to a polygon.

6. A method as recited in claim 3 wherein the terrestrial source comprises a cell tower.

7. A method as recited in claim 1 wherein broadcasting comprises broadcasting from a space-based source.

8. A method as recited in claim 6 wherein the space-based source comprises a satellite.

9. A method as recited in claim 1 wherein broadcasting comprises broadcasting from a stratospheric platform.

10. A method as recited in claim 1 wherein receiving the boundaries comprises receiving coordinates for each corner point.

11. A method as recited in claim 1 wherein receiving the boundaries comprises receiving latitude and longitude coordinates for each corner point.

12. A method as recited in claim 1 wherein controlling the device comprises controlling a display of a device.

13. A method as recited in claim 1 wherein broadcasting comprises broadcasting boundaries for multiple areas.

14. A method of operating a mobile device comprising:
broadcasting boundaries for a designated marketing area to a mobile device;
receiving the boundaries for the designated marketing areas;
storing the boundaries for the designated marketing area in a memory;
determining a location of the mobile device;
determining a designated marketing area fixed on the surface of the earth in response to the location and the boundaries in the memory;
broadcasting wireless signals have location specific information therein; and
displaying the wireless signals corresponding to the designated marketing area.

15. A method as recited in claim 14 further comprising receiving the wireless signals corresponding to the designated marketing area.

16. A method as recited in claim 14 further comprising prior to displaying, receiving the wireless signals and sorting the wireless information in response to the designated marketing area.

17. A method as recited in claim 14 wherein the mobile device comprises a mobile phone.

18. A method as recited in claim 14 wherein the mobile device comprises a personal electronic device.

19. A method of operating a mobile device comprising:
broadcasting boundaries for areas to a mobile device;
receiving the boundaries for the areas;
storing the boundaries for the areas in a memory;
determining a location of the mobile device;
determining a first area fixed on the surface of the earth of the mobile receiving device from the area;
receiving signals in response to the first area.

20. A method as recited in claim 19 wherein the area corresponds to a designated marketing area.

21. A method as recited in claim 20 wherein receiving signals comprises receiving local channels corresponding to the designated marketing area.

22. A method as recited in claim 19 wherein the area corresponds to a polygon.

23. A method as recited in claim 19 wherein determining a location comprises determining the location in response to a GPS receiver.

24. A method as recited in claim 19 wherein determining a location comprises determining the location in response to a GPS receiver disposed within an automotive vehicle.

25. A method as recited in claim 19 wherein determining a location comprises determining the location in response to a GPS receiver disposed within the mobile receiving device.

26. A method as recited in claim 19 wherein determining a location comprises determining the location in response to a cellular phone system.

27. A method as recited in claim 19 wherein the mobile receiving device comprises an integrated receiver decoder.

28. A method as recited in claim 19 wherein determining a location comprises determining a coordinate point and wherein determining a designated marketing area comprises determining the first area in response to comparing the coordinate point and the boundary for the first area in the memory.

29. A method of operating a receiving device comprising:
defining a plurality of designated marketing areas as a plurality of polygons having boundary points fixed on the surface of the earth;
broadcasting the boundary points for the designated marketing area to a mobile device;
receiving the boundary points for the designated marketing areas;
storing the boundary points for the designated marketing area in a memory;
determining a coordinate point of a mobile receiver;
comparing the boundary points from the memory to the coordinate points;
in response to comparing, determining a first designated marketing area from the plurality of designated marketing areas; and
receiving signals from the satellite in response to the first designated marketing area.

30. A method as recited in claim 29 wherein comparing comprises comparing using a raycasting technique.

31. A method as recited in claim 29 wherein the raycasting technique comprises generating a line from the coordinate point and counting the intersections with the first polygon to form a count, when the count is even, determining the point is outside a polygon and when the count is odd determining the coordinate point is inside a polygon.

32. A method as recited in claim 29 wherein the polygon comprises boundary points and a buffer zone.

33. A mobile television device coupled to a GPS receiver generating GPS signals comprising:
an antenna receiving boundary point data;
a controller coupled to the GPS receiver and the antenna, said controller storing the boundary point data, determining a location of a mobile receiving device in response to the GPS signals, determining a designated marketing area of the mobile television device in response to the GPS signals and the boundary point data, said controller selecting signals to receive from the satellite in response to the designated marketing area.
